(19) United States
(12) Patent Application Publication
(10) Pub. No.: US 2014/0260777 A1
(43) Pub. Date: Sep. 18, 2014

(54) VARIABLE INERTIA FLYWHEEL

(71) Applicant: DANA LIMITED, MAUMEE, OH (US)

(72) Inventor: Mark RJ Versteyhe, Oostkamp (BE)

(73) Assignee: DANA LIMITED, MAUMEE, OH (US)

(21) Appl. No.: 14/204,610

(22) Filed: Mar. 11, 2014

Related U.S. Application Data
(60) Provisional application No. 61/777,281, filed on Mar. 12, 2013.

(51) Int. Cl. F16F 15/31

(52) U.S. Cl. CPC F16F 15/31
USPC 74/572.2

(57) ABSTRACT

A variable inertia flywheel for an internal combustion engine is provided. The variable inertia flywheel device comprises at least two revolute joint assemblies, a roller guide, and a first actuator. The at least two revolute joint assemblies are in driving engagement with an output of the internal combustion engine. Each of the revolute joint assemblies comprises a member assembly and a roller. The roller guide is disposed about the revolute joint assemblies. An inner surface of the roller guide is in rolling contact with each of the rollers. The first actuator is in engagement with one of the roller guide and the revolute joint assemblies. The first actuator applies a force to one of the roller guide and the revolute joint assemblies to move one of the roller guide and the revolute joint assemblies along an axis defined by the output of the internal combustion engine.

### RELATED APPLICATIONS

The present application claims the benefit of U.S. Provisional Application No. 61/777,281 filed on Mar. 12, 2013, which is incorporated herein in its entirety by reference.

### FIELD OF THE INVENTION

The present invention relates to internal combustion engines and more specifically to a variable inertia flywheel for use with an internal combustion engine.

### BACKGROUND OF THE INVENTION

Due to recent improvements in combustion engine technology, there has been a trend to downsize internal combustion engines used in vehicles. Such improvements also result in more efficient vehicle, while maintaining similar performance characteristics and vehicle form factors favoured by consumers

One common improvement used with internal combustion engines is the addition of a supercharger or a turbocharger. Typically, the addition of the supercharger or the turbocharger is used to increase a performance of an engine that has been decreased in displacement or a number of engine cylinders. Such improvements typically result in an increased torque potential of the engine, enabling the use of longer gear ratios in a transmission of the vehicle. The longer gear ratios in the transmission enable a down-speeding of the engine. Engine down-speeding is a practice of operating the engine at lower operating speeds. Such improvements typically result in improved fuel economy, operation near their most efficient level for a greater amount of time compared to conventional engines, and reduced engine emissions.

In some designs, however, engine down-speeding can result in an undesirable increase in torque ripple at low operating speeds of the engine. For example, a significantly increased torque ripple can appear at an engine output when the engine is operating at low idle speeds. The torque ripple is a well-known engine dynamic that results from torque not being delivered constantly, but periodically during each power stroke of the operating cycle of an internal combustion engine. FIG. 1 is a graph illustrating a torque output of an engine during a four stroke cycle of an engine. In the four stroke cycle, the torque ripple happens once every two turns of a crankshaft for each cylinder of the engine. Accordingly, a four cylinder engine will have two torque ripples per crankshaft turn while a three cylinder engine will have three ripples every two crankshaft turns.

An amplitude of the torque ripple also varies with an operating speed of the engine and a load applied to the engine. A phase of the torque ripple varies with an operating speed and a load applied to the engine. Torque ripples can cause many problems for components of the vehicle near the engine, such as but not limited to: increased stress on the components, increased wear on the components, and exposure of the components to severe vibrations. These problems can damage a powertrain of the vehicle and result in poor drivability of the vehicle. In order to reduce the effects of these problems, smooth an operation of the engine, and improve an overall performance of the engine, the torque ripples may be compensated for using an engine balancing method. Many known solutions are available for multi-cylinder engine configurations to reduce or eliminate the stresses and vibration caused by the torque ripples.

Torque ripple compensator devices are known in the art; however, the known device have many shortcomings. In many conventional vehicles, the torque ripples are compensated for using at least one flywheel. FIG. 2 illustrates a conventional flywheel based damping system. In other applications, a dual-mass flywheel system may be used. An inertia of the flywheel dampens a rotational movement of the crankshaft, which facilitates operation of the engine running at a substantially constant speed. Flywheels may also be used in combination with other dampers and absorbers.

A weight of the flywheel, however, can become a factor in such torque ripple compensating devices. A lighter flywheel accelerates faster but also loses speed quicker, while a heavier flywheel retain speeds better compared to the lighter flywheel, but the heavier flywheel is more difficult to slow down. However, a heavier flywheel provides a smoother power delivery, but makes an associated engine less responsive, and an ability to precisely control an operating speed of the engine is reduced.

The main torque ripple occurs at the second order. Dual mass centrifugal pendulums with an internal cam profile are known devices that generate an opposite second order torque ripple to cancel out the second order main torque ripple. These devices, and their limitations, are further described below.

Dual mass centrifugal pendulum devices are known in the art. A rotating mass of a portion of the known dual mass centrifugal pendulum devices generates centrifugal forces. The centrifugal forces result in a generated torque, which is applied to an engine output shaft to counteract the torque ripples generated by the engine. The cammed surface is typically a non-circular profile which generates a variable torque on the engine output shaft as the rollers move radially inwardly and outwardly from the engine output shaft by following a shape of the cammed surface.

In addition to an increased weight of such devices, a fundamental problem of known variable inertia and damping systems is a lack of adaptability. Such devices are designed for a worst operational case and must have enough mass to damp vibrations at lower operational speeds. As a result, known devices are typically designed for higher operational speeds and have a tendency to inhibit vehicle performance and reduce a reactivity of the engine.

Known variable inertia and damping systems which compensate for amplitude of torque ripples do not compensate for a changing phase of the torque ripples generated by the engine. A phase of the torque ripples also varies based on a rotational speed of the engine and a load applied to the engine.

It would be advantageous to develop a variable inertia flywheel able to be dynamically adapted for both an amplitude and a phase of a torque ripple while minimizing an interference with an operation of an internal combustion engine.

### SUMMARY OF THE INVENTION

Presently provided by the invention, a variable inertia flywheel able to be dynamically adapted for both an amplitude and a phase of a torque ripple while minimizing an interference with an operation of an internal combustion engine, has surprisingly been discovered.

In one embodiment, the present invention is directed to a variable inertia flywheel for an internal combustion engine. The variable inertia flywheel comprises at least two revolute joint assemblies, a roller guide, and a first actuator. The at least two revolute joint assemblies are in driving engagement with an output of the internal combustion engine. Each of the revolute joint assemblies comprise a member assembly in driving engagement with and extending radially outwardly from the output of the internal combustion engine and a roller rotatably coupled to the member assembly. The roller guide is disposed about the revolute joint assemblies. An inner surface of the roller guide is in rolling contact with each of the rollers of the revolute joint assemblies. The first actuator is in engagement with one of the roller guide and the revolute joint assemblies. The first actuator applies a force to one of the roller guide and the revolute joint assemblies to move one of the roller guide and the revolute joint assemblies along an axis defined by the output of the internal combustion engine.

In another embodiment, the present invention is directed to a variable inertia flywheel for an internal combustion engine. The variable inertia flywheel comprises at least two revolute joint assemblies, a roller guide, and a first actuator. The at least two revolute joint assemblies are in driving engagement with an output of the internal combustion engine. Each of the revolute joint assemblies comprise a first member coupled to the output of the internal combustion engine, a second member pivotally coupled to the first member, and a roller rotatably coupled to the second member. The roller guide is disposed about the revolute joint assemblies. The roller guide has a substantially hollow conical shape. The inner surface of the roller guide defines at least two cam profiles and is in rolling contact with each of the rollers of the revolute joint assemblies. The first actuator is in engagement with one of the roller guide and the revolute joint assemblies. The first actuator applies a force to one of the roller guide and the revolute joint assemblies to move one of the roller guide and the revolute joint assemblies along an axis defined by the output of the internal combustion engine.

In yet another embodiment, the present invention is directed to a variable inertia flywheel for an internal combustion engine. The variable inertia flywheel comprises at least two revolute joint assemblies, a roller guide, a first actuator, and a second actuator. The at least two revolute joint assemblies are in driving engagement with an output of the internal combustion engine. Each of the revolute joint assemblies comprises a first member coupled to the output of the internal combustion engine, a second member pivotally coupled to the first member, and a roller rotatably coupled to the second member. A roller guide is disposed about the revolute joint assemblies. The roller guide has a substantially hollow conical shape. An inner surface of the roller guide defines at least two cam profiles and is in rolling contact with each of the rollers of the revolute joint assemblies. The first actuator is in engagement with one of the roller guide and the revolute joint assemblies. The second actuator is in engagement with the roller guide. The second actuator applies a force to the roller guide to rotate the roller guide about an axis defined by the output of the internal combustion engine. The first actuator applies a force to one of the roller guide and the revolute joint assemblies to move one of the roller guide and the revolute joint assemblies along an axis defined by the output of the internal combustion engine.

Various aspects of this invention will become apparent to those skilled in the art from the following detailed description of the preferred embodiment, when read in light of the accompanying, drawings.

### BRIEF DESCRIPTION OF THE FIGURES

The above, as well as other advantages of the present invention will become readily apparent to those skilled in the art from the following detailed description when considered in the light of the accompanying drawings in which:

FIG. 1 is a graph illustrating a torque output of an engine during a four stroke cycle of an engine;

FIG. 2 is a sectional view of a flywheel based damping system known in the prior art;

FIG. 3A is a schematic illustration of a variable inertia flywheel according to an embodiment of the present invention;

FIG. 3B is a sectional view of the variable inertia flywheel shown in FIG. 3A;

FIG. 4A is a schematic illustration of a variable inertia flywheel according to another embodiment of the present invention; and

FIG. 4B is a sectional view of the variable inertia flywheel shown in FIG. 4A.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

FIGS. 3A and 3B illustrate a variable inertia flywheel 100. The variable inertia flywheel 100 comprises a central shaft 102, at least two revolute joint assemblies 104, a roller guide 106, a guide actuator 108, and a flywheel housing 110. The central shaft 102 is in driving engagement with an internal combustion engine 112 and a transmission 114. The at least two revolute joint assemblies 104 are in driving engagement with the central shaft 102. A portion of each of the revolute joint assemblies 104 is in rolling contact with the roller guide 106. The roller guide 106 is disposed about the central shaft 102 and the revolute joint assemblies 104. The guide actuator 108 is in driving engagement with the roller guide 106 and the flywheel housing 110. The flywheel housing 110 is disposed about the roller guide 106 and the guide actuator 108. The flywheel housing 110 is coupled to at least one of the internal combustion engine 112 and the transmission 114.

The central shaft 102 is in driving engagement with the internal combustion engine 112 and a transmission 114. The central shaft 102 may form a portion of one of the internal combustion engine 112 and the transmission 114, or the central shaft 102 may be formed separate therefrom. The central shaft 102 is in driving engagement with the internal combustion engine 112 and the transmission 114 through splined connections formed on each end thereof; alternately, it is understood that the central shaft 102 may be in driving engagement with the internal combustion engine 112 and the transmission 114 in any other conventional manner. The central shaft 102 defines a primary axis A1 of the variable inertia flywheel 100.

The revolute joint assemblies 104 comprise at least a first member 116, a second member 118, and a roller 120. Each of the revolute joint assemblies 104 extends radially outwardly from the central shaft 102. As shown in FIGS. 3A and 3B, the variable inertia flywheel 100 includes two revolute joint assemblies 104 opposingly disposed on the central shaft 102.

The first member 116 is a rigid member coupled to the central shaft 102 at a first end thereof. The first member 116 may be pivotally coupled to the central shaft 102. The first member 116 is pivotally coupled to the second member 118 at a second end thereof.

The second member 118 is a rigid member pivotally coupled to the second end of the first member 116. A biasing member (not shown) may be disposed between the first member 116 and the second member 118 to urge the second member 118 away from the first member 116. The second member 118 is rotatably coupled to the roller 120 at an end thereof, opposite the first member 116. The first member 116 and the second member 118 form a member assembly 121.

The roller 120 is a ball or disk shaped member which is rotatably coupled to the second member 118. Alternately, the roller 120 may have other shapes. The roller 120 is configured to rotate about an axis substantially parallel to the primary axis A1. When the variable inertia flywheel 100 is assembled, the roller 120 is in rolling contact with the roller guide 106.

The roller guide 106 is a hollow rigid member disposed within the flywheel housing 110 and in driving engagement with the guide actuator 108. The roller guide 106 is also disposed about the central shaft 102 and each of the revolute joint assemblies 104. As shown in FIGS. 3A and 3B, the roller guide 106 is a substantially hollow conical shaped member, but it is understood that the roller guide 106 may have other shapes, which are described hereinbelow. An inner surface 122 of the roller guide 106, which is a generally conical shaped surface, defines at least two cam profiles 124. A quantity of the cam profiles 124 corresponds to a number of the revolute joint assemblies 104. In response to a force applied to the roller guide 106 by the guide actuator 108, the roller guide 106 may be moved axially along the primary axis A1.

The cam profiles 124 are elongate recesses defined by the inner surface 122 of the roller guide 106. A shape of each of the cam profiles 124 deviates from the inner surface 122, which is a generally conical shaped surface, of the roller guide 106. As shown in FIGS. 3A and 3B, the cam profiles 124 extend radially outwardly from the inner surface 122 and have a generally “U” shaped cross-section, but it is understood that the cam profiles 124 may have other shapes. The cam profiles 124 typically extend substantially along a whole length of the inner surface 122 of the roller guide 106; however, it is understood that the cam profiles 124 may only extend along a partial length of the inner surface 122. Further, the cam profiles 124 may vary in cross-sectional shape along the length of the inner surface 122. The cam profiles 124 have similar shapes and are opposingly oriented about the inner surface 122. The inner surface 122 may also define a plurality of cam profiles 124, separate form one another.

The guide actuator 108 is an actuator in driving engagement with the roller guide 106 and the flywheel housing 110. The guide actuator 108 may be a hydraulic actuator, a pneumatic actuator, a screw driven actuator, or any other type of known actuator. In response to a control signal from a controller (not shown), the guide actuator 108 applies a force to the roller guide 106 to move the roller guide 106 axially along the primary axis A1, changing a position of the revolute joint assemblies 104 with respect to the roller guide 106. It is also understood that the guide actuator 108 may be a passive guide actuator, including at least on biasing member to control a position of the roller guide 106.

The flywheel housing 110 is a hollow rigid body into which the central shaft 102, the at least two revolute joint assemblies 104, the roller guide 106, and the guide actuator 108 are disposed in. Typically, the flywheel housing 110 is substantially fixed with respect to the internal combustion engine 112. As a non-limiting example, the flywheel housing 110 is a housing removably coupled to the internal combustion engine 112 and the transmission 114; however, it is understood that the flywheel housing 110 may be another rigid body coupled to a portion of a vehicle (not shown) incorporating the variable inertia flywheel 100.

The internal combustion engine 112 applies power to the central shaft 102 through a crankshaft (not shown). The internal combustion engine 112, for example, is a four cycle internal combustion engine; however, it is understood that the internal combustion engine 112 may be another type of internal combustion engine that generates a torque ripple. It is understood that the internal combustion engine 112 may be a hybrid power source including both an internal combustion engine and an electric motor.

The transmission 114 facilitates driving engagement between the variable inertia flywheel 100 and a ground engaging device (not shown) in a plurality of drive ratios. The transmission 114 may be an automatic transmission, a manual transmission, a continuously variable transmission, or another type of transmission. As known in the art, the transmission 114 may include a clutching device (not shown).

FIGS. 4A and 4B illustrate a variable inertia flywheel 200. The variable inertia flywheel 200 is a variation of the variable inertia flywheel, and has similar features thereto. The variation of the invention shown in FIGS. 4A and 4B includes similar components to the variable inertia flywheel illustrated in FIGS. 3A and 3B. Similar features of the variation shown in FIGS. 4A and 4B are numbered similarly in series, with the exception of the features described below.

The variable inertia flywheel 200 comprises a central shaft 202, at least two revolute joint assemblies 204, a roller guide 240, a first guide actuator 242, a second guide actuator 244, and a flywheel housing 246. The central shaft 202 is in driving engagement with an internal combustion engine 212 and a transmission 214. The at least two revolute joint assemblies 204 are in driving engagement with the central shaft 202. A portion of each of the revolute joint assemblies 204 is in rolling contact with the roller guide 240. The roller guide 240 is disposed about the central shaft 202 and the revolute joint assemblies 204. The first guide actuator 242 and the second guide actuator 244 are in driving engagement with the roller guide 240 and the flywheel housing 210. The flywheel housing 210 is disposed about the roller guide 240, the first guide actuator 242, and the second guide actuator 244. The flywheel housing 210 is coupled to at least one of the internal combustion engine 212 and the transmission 214.

The roller guide 240 is a hollow rigid member rotatably disposed within the flywheel housing 246 and in driving engagement with the first guide actuator 242 and the second guide actuator 244. The roller guide 240 is also disposed about the central shaft 202 and each of the revolute joint assemblies 204. As shown in FIGS. 4A and 4B, the roller guide 240 is a substantially hollow conical shaped member, but it is understood that the roller guide 240 may have other shapes, which are described hereinbelow. The roller guide 240 is configured to rotate about an axis substantially coincident to the primary axis A1. An inner surface 248 of the roller guide 240, which is a generally conical shaped surface, defines at least two cam profiles 250. A quantity of the cam profiles 250 corresponds to a number of the revolute joint assemblies 204. In response to a force applied to the roller guide 240 by the first guide actuator 242, the roller guide 240 may be moved axially along the primary axis A1. In response to a force applied to the roller guide 240 by the second guide actuator 244, the roller guide 240 may be rotated about the primary axis A1.

The cam profiles 250 are elongate recesses defined by the inner surface 248 of the roller guide 240. A shape of each of the cam profiles 250 deviates from the inner surface 248, which is a generally conical shaped surface, of the roller guide 240. As shown in FIGS. 4A and 4B, the cam profiles 250 extend radially outwardly from the inner surface 248 and have a generally “U” shaped cross-section, but it is understood that the cam profiles 250 may have other shapes. The cam profiles 250 typically extend substantially along a whole length of the inner surface 248 of the roller guide 240; however, it is understood that the cam profiles 250 may only extend along a partial length of the inner surface 248. Further, the cam profiles 250 may vary in cross-sectional shape along the length of the inner surface 248. The cam profiles 250 have similar shapes and are opposingly oriented about the inner surface 248. The inner surface 248 may also define a plurality of cam profiles 250, separate form one another.

The first guide actuator 242 is an actuator in driving engagement with the roller guide 240 and the flywheel housing 246. The first guide actuator 242 may be a hydraulic actuator, a pneumatic actuator, a screw driven actuator, or any other type of known actuator. In response to a control signal from a controller (not shown), the first guide actuator 242 applies a force to the roller guide 240 to move the roller guide 240 axially along the primary axis A1, changing a position of the revolute joint assemblies 204 with respect to the roller guide 240. It is also understood that the first guide actuator 242 may be a passive guide actuator, including at least on biasing member to control a position of the roller guide 240.

The second guide actuator 244 is an actuator in driving engagement with the roller guide 240 and the flywheel housing 246. The second guide actuator 244 may be a hydraulic actuator, a pneumatic actuator, a screw driven actuator, or any other type of known actuator. In response to a control signal from the controller, the second guide actuator 244 applies a force to the roller guide 240 to rotate the roller guide 240 about the primary axis A1, changing a position of the cam profiles 250 of the roller guide 240 with respect to the primary axis A1.

The flywheel housing 246 is a hollow rigid body into which the central shaft 202, the at least two revolute joint assemblies 204, the roller guide 240, the first guide actuator 242, and the second guide actuator 244 are disposed in. Typically, the flywheel housing 246 is substantially fixed with respect to the internal combustion engine 212. As a non-limiting example, the flywheel housing 246 is a housing removably coupled to the internal combustion engine 212 and the transmission 214; however, it is understood that the flywheel housing 246 may be another rigid body coupled to a portion of a vehicle (not shown) incorporating the variable inertia flywheel 200.

In use, the variable inertia flywheel 100, 200 is drivingly engaged with the internal combustion engine 112, 212 through the central shaft 102, 202. The variable inertia flywheel 100, 200 is a parallel, torque additive device for the internal combustion engine 112, 212. By adjusting a position of the roller guide 106, 240, the variable inertia flywheel 100, 200 applies torque to the central shaft 102, 202 to correct a torque ripple generated by the internal combustion engine 112, 212. The variable inertia flywheel 100, 200 allows an amplitude and a phase of a torque generated by the variable inertia flywheel 100, 200 to be adjusted to correct a torque ripple generated by the internal combustion engine 112, 212.

As shown in FIGS. 3A, 3B, 4A, and 4B, the variable inertia flywheel 100, 200 includes two revolute joint assemblies 104, 204 and two the cam profiles 124, 250. The variable inertia flywheel 100, 200 including two revolute joint assemblies 104, 204 and two the cam profiles 124, 250 may be used to correct a torque ripple generated by an internal combustion engine having four cylinders. As a first non-limiting example, a variable inertia flywheel according to the invention as described herein including three revolute joint assemblies and three cam profiles may be used to correct a torque ripple generated by an internal combustion engine having six cylinders. As a second non-limiting example, a variable inertia flywheel according to the invention as described herein including four revolute joint assemblies and four cam profiles may be used to correct a torque ripple generated by an internal combustion engine having eight cylinders.

The equation below descries a relationship between several parameters and its derivatives over time which plays a crucial role in the generation of torque by the variable inertia flywheel 100, 200. The parameters are: an inertia of the revolute joint assemblies 104, 204, a rotational speed of the revolute joint assemblies 104, 204, and a mass of the revolute joint assemblies 104, 204.

$${T}_{gen} = \frac{1}{ω} \frac{d {E}_{kin}}{d t} , \\ {E}_{kin} = \sum \frac{{m}_{i} {v}_{i}^{2}}{2} + \frac{{J}_{i} {ω}_{i}^{2}}{2}$$

In the equation above T_{gen} is a torque generated by the variable inertia flywheel 100, 200, ω is a rotational speed of the revolute joint assemblies 104, 204 and Eₖᵢₙ is the kinetic energy of the revolute joint assemblies 104, 204. A varying inertia over time will thus generate a torque on the central shaft 102, 202.

By applying a force to the roller guide 106, 240 using the guide actuator 108 or the first guide actuator 242 to move the roller guide 106, 240 axially along the primary axis A1, an amplitude of a torque generated by the variable inertia flywheel 100, 200 can be adjusted to correct a torque ripple generated by the internal combustion engine 112, 212. The amplitude of a torque generated by the variable inertia flywheel 100, 200 is adjusted by changing a position of the roller guide 106, 240 with respect to the revolute joint assemblies 104, 204.

By moving the roller guide 106, 240 axially along the primary axis A1 while the revolute joint assemblies 104, 204 rotate within the roller guide 106, 240, a radius of the revolute joint assemblies 104, 204 can be controlled. In response to a change of a radius of the revolute joint assemblies 104, 204, an average inertia of the revolute joint assemblies 104, 204 also changes. Adjustment of a position of the roller guide 106, 240 during operation of the internal combustion engine 112, 212 using the controller may highly reduce torque ripples generated by the internal combustion engine 112, 212, without concern for under correction or over correction.

Control of the amplitude of a torque generated by the variable inertia flywheel 100, 200 permits the variable inertia flywheel 100, 200 to generate a higher inertia (through a greater radius of the revolute joint assemblies 104, 204) at lower operating speeds of the internal combustion engine 112, 212 and a lower inertia (through a smaller radius of the revolute joint assemblies 104, 204) at higher operating speeds of the internal combustion engine 112, 212.

It is also understood that as an alternative to the embodiments of the invention described herein, it is within the scope of the present invention to change a position of the revolute joint assemblies 104, 204 with respect to the roller guide 106, 240 to adjust an amplitude of a torque generated by the variable inertia flywheel 100, 200.

By applying a force to the roller guide 240 using the second guide actuator 244 to rotate the roller guide 240 about the primary axis A1, a phase of a torque generated by the variable inertia flywheel 200 can be adjusted to correct a torque ripple generated by the internal combustion engine 212. The phase of a torque generated by the variable inertia flywheel 200 is adjusted by changing a position of the cam profiles 250 of the roller guide 240 with respect to the primary axis A1.

The phase of the torque ripple generated by the internal combustion engine 212 is not constant and varies with an operating speed and a load applied to the internal combustion engine 212. Thus, the phase angle of a torque generated by the variable inertia flywheel 200 needs to be adapted based on such parameters. The phase angle of a torque generated by the variable inertia flywheel 200 can be controlled using two methods.

In a first method, which is mentioned above, by changing a position of the cam profiles 250 of the roller guide 240 with respect to the primary axis A1 (through a rotation of the roller guide 240 using the second guide actuator 244, the phase angle of a torque generated by the variable inertia flywheel 200 is adjusted.

In a second method, which is similar to adjusting the amplitude of a torque generated by the variable inertia flywheel 100, 200 (but having a different end result), a position of the roller guide 106, 240 with respect to the revolute joint assemblies 104, 204 is adjusted to. In the second method, a design of the cam profiles 124, 250 are shaped to adjust the phase angle of a torque generated by the variable inertia flywheel 100, 200. By varying a shape of the cam profiles 124, 250 along a length of the inner surface 122, 248 of the roller guide 106, 240, a phase angle of a torque generated by the variable inertia flywheel 100, 200 is adjusted as an amplitude is adjusted, in response to a rotational speed of the internal combustion engine 112, 212, for example. It is understood that a design of the cam profiles 124, 250 of the roller guide 106, 240 would incorporate a necessary shape to adjust a phase angle of a torque generated by the variable inertia flywheel 100, 200. Similarly, it is also understood that a design of the cam profiles 124, 250 of the roller guide 106, 240 would incorporate a necessary shape to adjust a phase angle of a torque generated by the variable inertia flywheel 100, 200 by using the second guide actuator 244 to rotate the roller guide 240 about the primary axis A. It is also understood that the first method and the second method may be combined.

Based on the foregoing, it can be appreciated that the variable inertia flywheel 100, 200 described and depicted herein has several advantages over the known art. Some of the advantages of the variable inertia flywheel 100, 200 include, but are not limited to, providing a torque ripple compensation that can be actively regulated in an amplitude and a phase. Additionally, the energy consumption of the variable inertia flywheel 100, 200 is not significant, as any losses associated with the operation of the variable inertia flywheel 100, 200 would be minor. As described hereinabove, the variable inertia flywheel 100, 200 can be applied for any driving speed of a vehicle incorporating the variable inertia flywheel 100, 200. Accordingly, a driving performance of the vehicle can be maintained, and a torque generated by the variable inertia flywheel 100, 200 can be adjusted based on an operating speed of the internal combustion engine 112, 212. Additionally, the variable inertia flywheel 100, 200 may be retrofit to existing engines to address torque ripple concerns. Further, through use of the variable inertia flywheel 100, 200, a torque ripple generated by the internal combustion engine 112, 212 can be actively canceled. As a result, an amount of inertia required to reduce an effect of torque ripples can be decreased, which results in an improved driving performance of the vehicle incorporating the variable inertia flywheel 100, 200.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A variable inertia flywheel for an internal combustion engine, the variable inertia flywheel comprising:
at least two revolute joint assemblies in driving engagement with an output of the internal combustion engine, each of the revolute joint assemblies comprising;
a member assembly in driving engagement with and extending radially outwardly from the output of the internal combustion engine, and
a roller rotatably coupled to the member assembly;
a roller guide disposed about the revolute joint assemblies, an inner surface of the roller guide in rolling contact with each of the rollers of the revolute joint assemblies; and
a first actuator in engagement with one of the roller guide and the revolute joint assemblies, wherein the first actuator applies a force to one of the roller guide and the revolute joint assemblies to move one of the roller guide and the revolute joint assemblies along an axis defined by the output of the internal combustion engine.

2. The variable inertia flywheel of claim 1, further comprising a flywheel housing into which the revolute joint assemblies, the roller guide, and the first actuator are disposed in.

3. The variable inertia flywheel of claim 2, wherein the first actuator is in engagement with the roller guide and the flywheel housing.

4. The variable inertia flywheel of claim 2, wherein the flywheel housing is coupled to the internal combustion engine.

5. The variable inertia flywheel of claim 1, wherein the roller guide is a substantially hollow conical shaped member.

6. The variable inertia flywheel of claim 1, wherein the inner surface of the roller guide defines at least two cam profiles.

7. The variable inertia flywheel of claim 6, wherein the cam profiles are elongate recesses defined by the inner surface of the roller guide and extend radially outwardly from the inner surface of the roller guide.

8. The variable inertia flywheel of claim 6, wherein the cam profiles extend substantially along a whole length of the inner surface of the roller guide.

9. The variable inertia flywheel of claim 1, wherein the member assembly comprises a first member coupled to the output of the internal combustion engine and a second member pivotally coupled to the first member.

10. The variable inertia flywheel of claim 1, further comprising a second actuator in engagement with the roller guide, wherein the second actuator applies a force to the roller guide to rotate the roller guide about an axis defined by the output of the internal combustion engine

11. The variable inertia flywheel of claim 1, wherein the first actuator is a passive guide actuator.

12. The variable inertia flywheel of claim 11, wherein the first actuator comprises at least one biasing member.

13. A variable inertia flywheel for an internal combustion engine, the variable inertia flywheel comprising:
at least two revolute joint assemblies in driving engagement with an output of the internal combustion engine, each of the revolute joint assemblies comprising;
a first member coupled to the output of the internal combustion engine,
a second member pivotally coupled to the first member, and
a roller rotatably coupled to the second member;
a roller guide disposed about the revolute joint assemblies, the roller guide having a substantially hollow conical shape, an inner surface of the roller guide defining at least two cam profiles and in rolling contact with each of the rollers of the revolute joint assemblies; and
a first actuator in engagement with one of the roller guide and the revolute joint assemblies, wherein the first actuator applies a force to one of the roller guide and the revolute joint assemblies to move one of the roller guide and the revolute joint assemblies along an axis defined by the output of the internal combustion engine.

14. The variable inertia flywheel of claim 13, wherein the inner surface of the roller guide defines at least two cam profiles.

15. The variable inertia flywheel of claim 14, wherein the cam profiles are elongate recesses defined by the inner surface of the roller guide and extend radially outwardly from the inner surface of the roller guide.

16. The variable inertia flywheel of claim 14, wherein the cam profiles extend substantially along a whole length of the inner surface of the roller guide.

17. The variable inertia flywheel of claim 13, further comprising a second actuator in engagement with the roller guide, wherein the second actuator applies a force to the roller guide to rotate the roller guide about an axis defined by the output of the internal combustion engine.

18. A variable inertia flywheel for an internal combustion engine, the variable inertia flywheel comprising:
at least two revolute joint assemblies in driving engagement with an output of the internal combustion engine, each of the revolute joint assemblies comprising;
a first member coupled to the output of the internal combustion engine,
a second member pivotally coupled to the first member, and
a roller rotatably coupled to the second member;
a roller guide disposed about the revolute joint assemblies, the roller guide having a substantially hollow conical shape, an inner surface of the roller guide defining at least two cam profiles and in rolling contact with each of the rollers of the revolute joint assemblies;
a first actuator in engagement with one of the roller guide and the revolute joint assemblies; and
a second actuator in engagement with the roller guide, wherein the second actuator applies a force to the roller guide to rotate the roller guide about an axis defined by the output of the internal combustion engine and the first actuator applies a force to one of the roller guide and the revolute joint assemblies to move one of the roller guide and the revolute joint assemblies along an axis defined by the output of the internal combustion engine.

19. The variable inertia flywheel of claim 18, wherein the inner surface of the roller guide defines at least two cam profiles.

20. The variable inertia flywheel of claim 19, wherein the cam profiles are elongate recesses defined by the inner surface of the roller guide and extend radially outwardly from the inner surface of the roller guide.
